(19) United States
(12) Patent Application Publication
(10) Pub. No.: US 2006/0175357 A1
(43) Pub. Date: Aug. 10, 2006

(54) Valve

(76) Inventor: Geoffrey Robert Hammond, Hull (GB)

Correspondence Address: NORRIS, MCLAUGHLIN & MARCUS, 875 THIRD AVE, 18TH FLOOR, NEW YORK, NY, 10022, US

(21) Appl. No.: 10/473,118

(22) PCT Filed: Mar. 27, 2002
(86) PCT No.: PCT/GB02/01187

§ 371 Date: Mar. 26, 2004

(30) Foreign Application Priority Data
Mar. 29, 2001 (GB) 0107858.3

(51) Int. Cl. B65D 25/40

(52) U.S. Cl. 222/394; 222/491; 137/843

(57) ABSTRACT

A valve for an aerosol comprises a valve body 1 and a surrounding rubber sleeve 2. The body defines an inlet and outlet passages 3, 4 and bores 5, 6 connecting these passages to the surface of the valve. When the pressure of fluid in the inlet passage 3 and bore 5 builds to a sufficient value the sleeve is pushed away from the body permitting flow through the bores between the passages. When the pressure falls the sleeve closes the bores to interrupt the flow.

The present invention relates to a valve. The valve is particularly but not exclusively intended for use with a pressured or pressurisable container.

Manually operated finger or trigger sprays are commonly used to dispense household products such as hard surface cleaners. A problem with such sprays is that they can give a poor spray pattern if the consumer operates the spray at too low a pressure. Also they can dribble. A solution to these problems is sought.

Also sought is a device which can automatically generate a pulsed release from an aerosol container.

According to a first aspect of the present invention there is provided a valve comprising a valve body and a flexible member surrounding the valve body, the valve body defining an inlet and an outlet and means for enabling the inlet and outlet to communicate and the flexible member being displaceable under the action of pressure in the inlet from a position in which communication between inlet and outlet is prevented to a position in which communication between inlet and outlet is permitted.

In a preferred embodiment of the invention, the valve body may be moulded from synthetic plastics material or made from metal or any other suitable material.

The flexible member preferably comprises a sleeve advantageously made of rubber or synthetic plastics material. An elastomeric material is preferred. Its interior surface is preferably tacky so that it adheres to the valve body. This is a preferred feature because whilst the tackiness of the flexible member will increase the initial pressure required to displace the flexible member from the position in which communication between inlet and outlet is prevented to a position in which communication between inlet and outlet is permitted, the final pressure at which the flexible member returns to its original position is unchanged.

Suitably, the sleeve may be made of a material which requires more energy to deform/stretch it than the energy that the sleeve can exert through elasticity to return to its original position when the displacing force is removed.

Accordingly there will be a period of time during which gas or liquid can pass from the inlet to the outlet whilst the pressure drops from the initial pressure to the final pressure. Thus by careful selection of the material for the flexible membrane and/or by applying a tackifying coating to the interior surface of the member, the release characteristics of the valve can be selected.

In one embodiment a valve of the invention is employed in a pressurisable device, for example a trigger spray. The valve only opens once a threshold operating force has been applied and so releases a high quality spray, without dripping or dribbling.

In another embodiment a valve of the invention is employed in a pressurised device, for example a spray canister, and is arranged such that propellant bleeds into the valve, and intermittently trips the valve, without the agency of a user.

The means for enabling the inlet and outlet to communicate preferably comprises bores respectively connecting the inlet and outlet with the surface of the valve body. Optionally the valve includes more than one bore for either or both of the inlet and outlet.

Means are provided for retaining the flexible member on the valve body. These means preferably comprise annular formations on the valve body.

According to the invention there is further provided a device incorporating a valve as defined above. The device is optionally either pressurised, for example an aerosol, or pressurisable. In the latter case, the pressure in the device is generally generated manually (e.g. by a finger pump) or automatically (e.g. chemically or by a mechanical pump). In the former case the device preferably comprises a first chamber containing a pressurised liquid propellant and a second chamber containing liquid material to be issued from the device in dispersed form, wherein there is restricted communication between the chambers such that propellant may bleed into the second chamber. A valve according to the present invention is in communication with the second chamber and in use issues a pulse of the said material once the propellant has raised the pressure within the second chamber to a threshold level required to operate the valve.

In principle the dual-chamber device just described could be used with any precompression valve (by which we mean a valve which opens only once a given fluid pressure has been reached; and preferably which closes at a lower pressure); such a dual-chamber device with any precompression chamber constitutes a further aspect of the present invention. The valve may be permanently attached to the device or may be coupled when the user replaces the pressurised/pressurisable unit as a refill.

In order that the invention may be more clearly understood, one embodiment thereof will now be described, by way of example, with reference to the accompanying drawings, in which:—

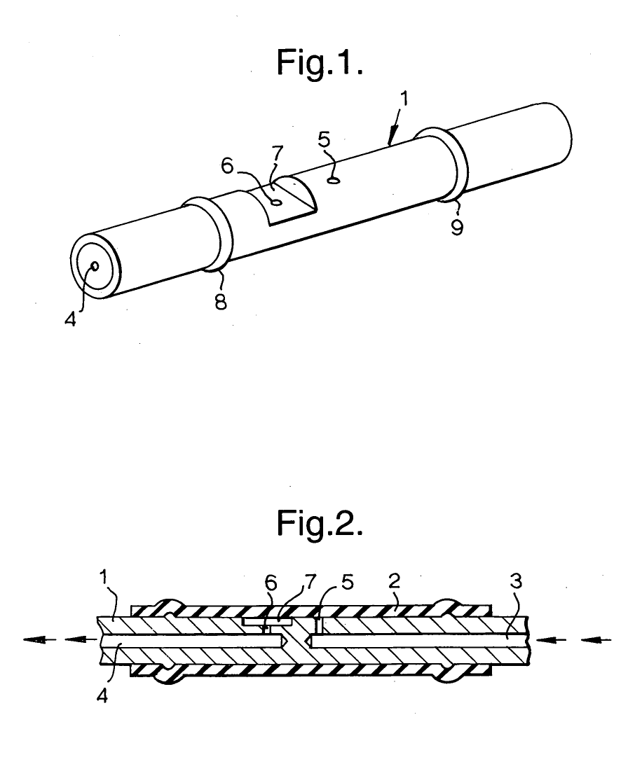

FIG. 1 is a perspective view of part of one form of valve;

FIG. 2 is a cross-sectional view of a valve including the part shown in FIG. 1;

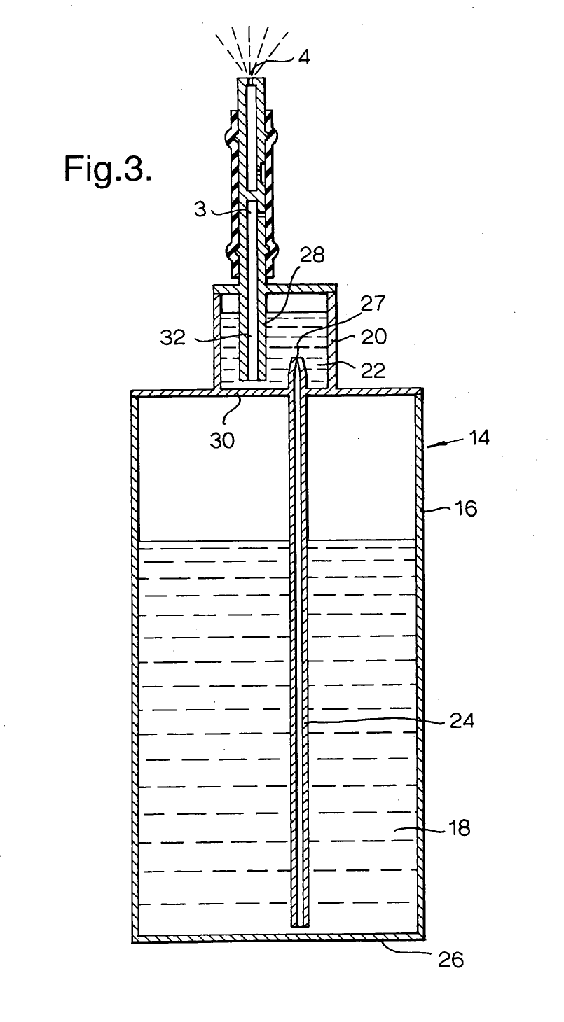

FIG. 3 shows a first embodiment of aerosol device having a valve as shown in FIG. 2; and

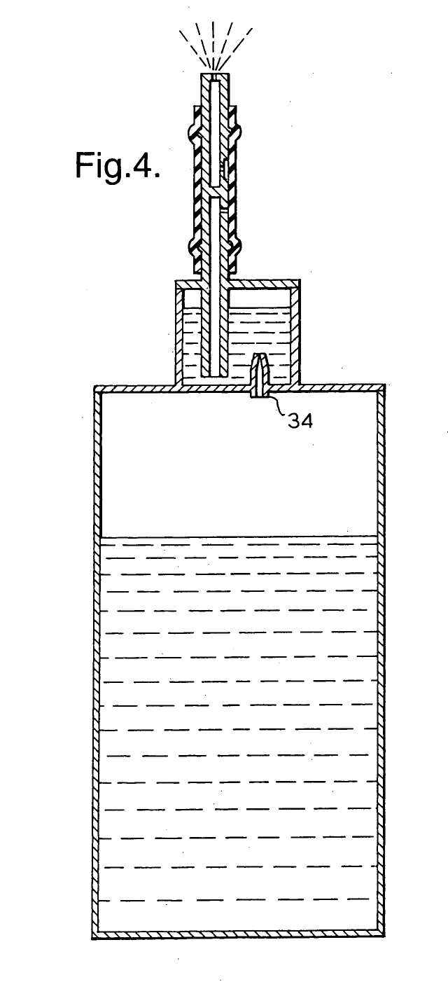

FIG. 4 shows a second embodiment of aerosol device having a valve as shown in FIG. 2.

Referring to the figures, the valve comprises a substantially cylindrical valve body 1 and a flexible member 2 which is in the form of a sleeve over the valve body 1. The valve body 1 is injection moulded from synthetic plastics material, but may be made from metal or any other suitable material. The body defines centrally located and axially extending inlet 3 and outlet 4. The body 1 also defines a bore 5 which extends from the surface of the body 1 to the inlet 3, and a bore 6 which extends from the surface of the body to the outlet 4. At the point at which the bore 6 meets the body surface, a recess 7 is formed in the body surface. The recess may be of flat cut-out form as shown in FIG. 1 or may be an annular recess extending around the whole or part of the circumference of body 1. Two annular formations 8 and 9 are extensions to the body surface disposed on opposite sides respectively of the recess 7 and bore 5.

The flexible member 2 is dimensioned to grip the body 1 with a close fit. The sleeve may be made of rubber, plasticised polyvinylchloride (pvc) or any other suitable material. The material has an adhesive property which provides an attractive force between the member 2 and body 1 when the two are in contact. Alternatively it may be made of a material which requires more energy to deform/stretch it than the energy that the sleeve can exert through elasticity to return to its original position when the displacing force is removed.

In use, with insufficient pressure in the inlet 3, the valve will be closed as shown in FIG. 2. As the pressure increases in inlet 3, a value is reached which overcomes any attractive force between member 2 and body 1 and/or the force exerted by the elasticity of the sleeve and lifts the member 2 away from the body 1 allowing gas or fluid to flow into the recess 7 and from there via bore 6 to outlet 4. Flow will continue as long as the pressure of the fluid is sufficient to hold the member 2 away from the body 1. When the pressure falls to a value which is insufficient to hold the member 2 away from the body, the member will reseal against the body 1 thus closing off the flow between inlet 3 and outlet 4. The closing pressure will normally be less than the opening pressure where the aforementioned attractive force is present. The interaction of the member 2 on the formations 8 and 9 form respective seals opposing any tendency for fluid or gas to escape at opposite axial ends of the member 2. These formations act as retainers to prevent axial movement of the member 2 on the body 1 or leakage from the valve by any route other than by outlet 4 as a higher pressure will be needed to lift sleeve 2 away from formations 8 and 9 than will be needed to lift the sleeve to allow communication between bores 5 and 6. Alternatively, external clamps may be used to prevent leakage.

The valve may be used to control the output from a pressurised or pressurisable device. Pressure in the pressurisable device is generally either generated manually (e.g. by finger pump or a trigger pump) or automatically (e.g. by chemical means or by a mechanical pump). In both cases, once the valve threshold opening pressure is exceeded the valve will open to release a portion of the device's contents and close again once the pressure has fallen to the appropriate lower value.

FIG. 3 illustrates a pressurised device 14 incorporating a valve according to the invention. The device has a main chamber 16 containing a pressurised liquid propellant 18, and a smaller chamber 20 on top of the main chamber. The smaller chamber 20 contains an atomisable liquid 22, for example a fragrance. The only communication between the chambers is by means of an upright dip tube 24. The lower end of the dip tube is close to the bottom wall 26 of the main chamber. The upper end of the dip tube tapers to a pinhole 27. In an alternative embodiment the upper end of the dip tube may be closed by a gas-permeable liquid-impermeable membrane.

The smaller chamber has an outlet device in the form of the valve of FIGS. 1 and 2, arranged upright with the outlet 4 uppermost. It will be seen that the body 4 is formed as one piece with an upright tubular formation 28 within the smaller chamber and passing through the upper wall thereof. The bore 32 of the formation 28 communicates with the inlet 3 of the valve. The lower end of the formation 28 is close to the bottom wall 30 of the upper chamber.

In operation, the propellant in the main chamber bleeds into the smaller chamber via the dip tube 24 at a rate controlled by the dimensions of its pinhole outlet. Once the pressure in the smaller chamber is sufficient to operate the valve, liquid 22 from the chamber is released into the environment and then the valve closes. This process occurs repeatedly. Accordingly the device gives pulsed release of the liquid in the smaller chamber.

The embodiment of FIG. 4 is similar to that of FIG. 3 except there is no dip tube. Communication between the chamber is via a short tubular stub 34 whose lower end is in the upper region of the main chamber, in the headspace region of pressurised gas above the liquid propellant, and whose tapered upper end, closed by a gas-permeable liquid-impermeable membrane, is in the lower region of the upper chamber. Like the device of FIG. 3 the FIG. 4 device operates to give intermittent release of material, typically fragrance. One advantage of the FIG. 4 arrangement is that its performance is substantially unaffected by changes in the liquid's viscosity.

It will be appreciated that the above embodiments have been described by way of example only and that many variations are possible without departing from the scope of the invention. In one variation, instead of a single bore 5, a plurality of circumferentially spaced bores may be provided to distribute pressure from the inlet passage 3 around the body 1 thus lifting the member 2 away from the body around the circumference rather than simply at one point.

In other embodiments the force required to operate the valve is supplied by a user. A weak force which might be expected to produce a dribble of liquid in prior devices does not produce any output. A moderate force opens the valve and the pressure is already sufficient to produce a good quality aerosol spray.

1. A valve comprising a valve body and a flexible member surrounding the valve body, the valve body defining an inlet and an outlet and means for enabling the inlet and outlet to communicate and the flexible member being displaceable under the action of pressure in the inlet from a closed position in which communication between inlet and outlet is prevented to an open position in which communication between inlet and outlet is permitted, wherein the interior surface of the flexible member is tacky so that it adheres to the valve body so as to increase the force required to displace the flexible member from the closed position to the open position, the force at which the flexible member returns to its closed position being unchanged, and/or wherein the flexible member is constructed of a material which requires greater force to displace it from the closed position than the force that the flexible member can exert through elasticity to return to its closed position when the displacing force is removed.

2. A valve as claimed in claim 1, in which the valve body is moulded from synthetic plastics material.

3. A valve as claimed in claim 1, in which the valve body is made from metal.

4. A valve as claimed in claim 1, in which the flexible member comprises a sleeve.

5. A valve as claimed in claim 1, in which the flexible member is made from rubber.

6. A valve as claimed in claim 1, in which the flexible member is made from a synthetic plastics material.

7. A valve as claimed in claim 1 wherein the interior surface of the flexible member is provided with a tackifying coating.

8. A valve as claimed in claim 1, in which the means for enabling the inlet and outlet to communicate comprises bores respectively connecting the inlet and outlet with the surface of the valve body.

9. A valve as claimed in claim 1, in which means are provided for retaining the flexible member on the valve body.

10. A valve as claimed in claim 9, in which the means comprise annular formations on the valve body.

11. A device incorporating a valve according to claim 1.

12. A device as claimed in claim 11 which is pressurisable.

13. A device as claimed in claim 12 wherein the pressure in the device is generated by means of a manual pump.

14. A device as claimed in claim 11 which has a pressurised container.

15. A device as claimed in claim 14 which provides a pulsed release of the contents of the pressurised container.

16. A device comprising a first chamber containing a pressurised liquid propellant and a second chamber containing in liquid form a material to be issued from the device in dispersed form, wherein there is restricted communication between the chambers such that propellant may bleed into the second chamber, and wherein a valve providing intermittent communication between the second chamber and the exterior of the device issues a pulse of the said material once the propellant has raised the pressure within the second chamber to a threshold level required to operate the valve.

17. A device as claimed in claim 16 comprising a valve having a valve body and a flexible member surrounding the valve body, the valve body defining an inlet and an outlet and means for enabling the inlet and outlet to communicate and the flexible member being displaceable under the action of pressure in the inlet from a closed position in which communication between inlet and outlet is prevented to an open position in which communication between inlet and outlet is permitted, wherein the interior surface of the flexible member is tacky so that it adheres to the valve body so as to increase the force required to displace the flexible member from the closed position to the open position, the force at which the flexible member returns to its closed position being unchanged, and/or wherein the flexible member is constructed of a material which requires greater force to displace it from the closed position than the force that the flexible member can exert through elasticity to return to its closed position when the displacing force is removed.
